(19) United States
(12) Patent Application Publication
(10) Pub. No.: US 2005/0255901 A1
(43) Pub. Date: Nov. 17, 2005

(54) Method and apparatus for testing players' knowledge of artistic works

(76) Inventor: Richard W. Kreutzer, Sandy, UT (US)

Correspondence Address: GRANT R CLAYTON;CLAYTON HOWARTH & CANNON, PC, P O BOX 1909, SANDY, UT, 84091-1909, US

(21) Appl. No.: 10/985,799

(22) Filed: Nov. 11, 2004

Related U.S. Application Data
(60) Provisional application No. 60/571,044, filed on May 14, 2004.

(51) Int. Cl. G06F 17/00; G06F 19/00

(52) U.S. Cl. 463/9

(57) ABSTRACT

An interactive game for entertainment or competition whereby players compete to identify information about artistic works such as songs, movies, paintings, and literary works. The artistic works are stored digitally and are rendered on demand by the players. The first player to correctly identify the sought after information scores. In addition, targeted advertisements based upon the players' interests or answers may be placed to be perceived by one or more players during game play.

### CROSS-REFERENCE TO RELATED APPLICATIONS

This application claims the benefit of U.S. Provisional Application No. 60/571,044, filed May 14, 2004, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

1. The Field of the Disclosure.

The present disclosure relates generally to providing entertainment, and more particularly, but not necessarily entirely, to providing entertainment by testing a person's knowledge of artistic works rendered by electronic devices.

2. Related Art

In the past, many games have been developed to test a person's knowledge. These games take many forms. One type of game, commonly referred to a trivia game, requires a player to respond to a question with a correct answer. The questions are typically read by another player from a card. In one version of the trivia games, players advance game pieces on a playing board for each correct answer.

The previously available games include a wide range of games utilizing the question and answer format for music trivia. U.S. Pat. No. 5,893,561 discloses a music trivia game comprising a plurality of question cards containing both questions and answers. Each of the cards has musical questions arranged in categories of decades that relate to spaces on a game board. An electronic answer indicator is located in the center of the game board. The answer indicator plays a song with a positive theme if a correct answer is given and a song with a negative theme if an incorrect answer is given.

U.S. Pat. No. 5,433,449 discloses a game to test players' knowledge of rock and roll songs. The disclosed game employs a plurality of cards, each of the cards having the name of an artist and title on top of the card and the words from a rock an roll song beneath the artist and title of the song. The game also includes a game board and two die.

U.S. Pat. No. 5,899,456 discloses a trivia game using question cards. The game requires a playing board, game pieces, a multi-sided die, and question and answer cards. The front side of each of the cards depicts a symbol for each question category. Next to each symbol is a listing of elements. The elements are related to the trivia answer. The listing of elements, for example, may include a listing of actors from which the players must guess the name of a movie.

U.S. Pat. No. 5,486,006 discloses a question-and-answer format quiz game having a music theme. The game is based upon questions wherein a song title and year are identified and a player is requested to identify the artist that performed the song.

Another previously known game type required players to guess the name of a tune after the tune, or a short portion thereof, is played. Many early television shows incorporated variations of this game. One such show had a live band play a song during which phone calls were placed at random to anyone in the broadcast area. A listener who answered his or her phone and correctly identified the tune won a prize. Another television show had two contestants competing to name a tune before the other contestant. In addition, each contestant would try to see if the tune could be named using the least number of notes. Home versions of the television shows were also available in an attempt to capitalize on the popularity of the shows.

Other types of previously known games include games requiring the players to guess some point of information based upon another player's performance. One such popular game is known as charades. Charades requires that one of the players act out a situation while the other players attempt to guess something about the situation. U.S. Pat. No. 4,932,667 discloses a performing artist game. In this game, players must answer part or all of a question based upon the performance of another player. The questions may include guessing the name of an actor, location, product, program, movie, play or song based upon the performance.

The features and advantages of the disclosure will be set forth in the description which follows, and in part will be apparent from the description, or may be learned by the practice of the disclosure without undue experimentation. The features and advantages of the disclosure may be realized and obtained by means of the instruments and combinations particularly pointed out in the appended claims.

### BRIEF DESCRIPTION OF THE DRAWINGS

The features and advantages of the disclosure will become apparent from a consideration of the subsequent detailed description presented in connection with the accompanying drawings in which:

FIG. 1 is block diagram of one illustrative embodiment of the present invention;

FIG. 2 is a block diagram of another illustrative embodiment of the present invention;

FIG. 3 illustrates a portion of an example index in accordance with one illustrative embodiment of the present invention.

FIG. 4 is a flow diagram representing one illustrative aspect of the present invention;

FIG. 5 is a flow diagram representing another illustrative aspect of the present invention;

FIG. 6 is a flow diagram representing still another illustrative aspect of the present invention;

FIG. 7 is a flow diagram representing yet another illustrative aspect of the present invention;

FIG. 8 is a flow diagram representing another illustrative aspect of the present invention; and

FIG. 9 is a flow diagram representing a further illustrative aspect of the present invention.

### DETAILED DESCRIPTION

For the purposes of promoting an understanding of the principles disclosed herein, reference will now be made to the embodiments illustrated in the drawings and specific language will be used to describe the same. It will nevertheless be understood that no limitation of the scope of the disclosure or the claimed invention is thereby intended. Any alterations and further modifications of the inventive features illustrated herein, and any additional applications of the principles of the disclosure as illustrated herein, which would occur to one skilled in the relevant art and having possession of this disclosure, are to be considered within the scope of the disclosure claimed.

It must be noted that, as used in this specification and the appended claims, the singular forms “a,” “an,” and “the” include plural referents unless the context clearly dictates otherwise.

In describing and claiming the present disclosure, the following terminology will be used in accordance with the definitions set out below.

As used herein, the terms “comprising,” “including,” “containing,” “characterized by,” and grammatical equivalents thereof are inclusive or open-ended terms that do not exclude additional, unrecited elements or method steps.

As used herein, the term “artistic work” means a creation of a person in any medium. This may include, without limitation, musical compositions, performances, speeches, literary compositions, drawings, paintings, films, television productions, television shows, sculptures, designs, plans, and man-made things of any nature, including those of a factual nature. It will be appreciated that artistic works or representations of artistic works may be stored digitally in an electronic storage medium in a digital format that is able to convey the work similar to the original medium. These formats may include formats suitable for audio, still images, video or any other humanly perceptible information and any combination thereof.

As used herein, the term “identifying indicia” refers to any piece of information relating to an artistic work that may be ascertainable by perceiving the work. Typically, identifying indicia are facts or trivia about an artistic work that are guessed by a player but may also include other information. Identifying indicia may be relatively well-known to provide an low difficultly level for the player or more obscure to increase the difficulty level for the player. As used herein, the terms “answer,” “guess” or “guessing” include within their meanings conjecture, supposition, supposition and surmised responses.

Identifying indicia may include, without limitation, the name of a person associated with the work such as a performer, an author, an actor, a composer, a painter, a director, a producer, the name of a group performing the artistic work such as a band or orchestra name, a title of the artistic work or a larger work to which it belongs, a year associated with the work such as the year of release, and a name of a genre, movement or style to which the work belongs, as well as other pertinent information. Identifying indicia may also include additional characteristics as will be understood by those skilled in the art applying the teachings set forth herein.

Applicant has arrived at an interactive system and method of amusement, also referred to as a game, which assesses or tests players' knowledge of artistic works. The game may be played either by a single player or a group of players with the aid of an electronic device. Digitally stored artistic works are rendered with the electronic device, and the players compete to be the first to guess an identifying indicia about the artistic work. Players may be awarded points for a correct answer or a prize, such as a free music download, and optionally advancement of a piece on a game board, or other reward as will be appreciated by those skilled in the art using the disclosure provided herein.

The game may be played over a network, such as a global computer network known as the Internet, between a server and a client or between peers on a network. The game may also be played on other types of electronic devices capable of rendering a work. In addition, targeted advertisements based upon game parameters or the players' knowledge as ascertained from game play may be dispersed throughout the game to solicit the purchase of products or services by the players.

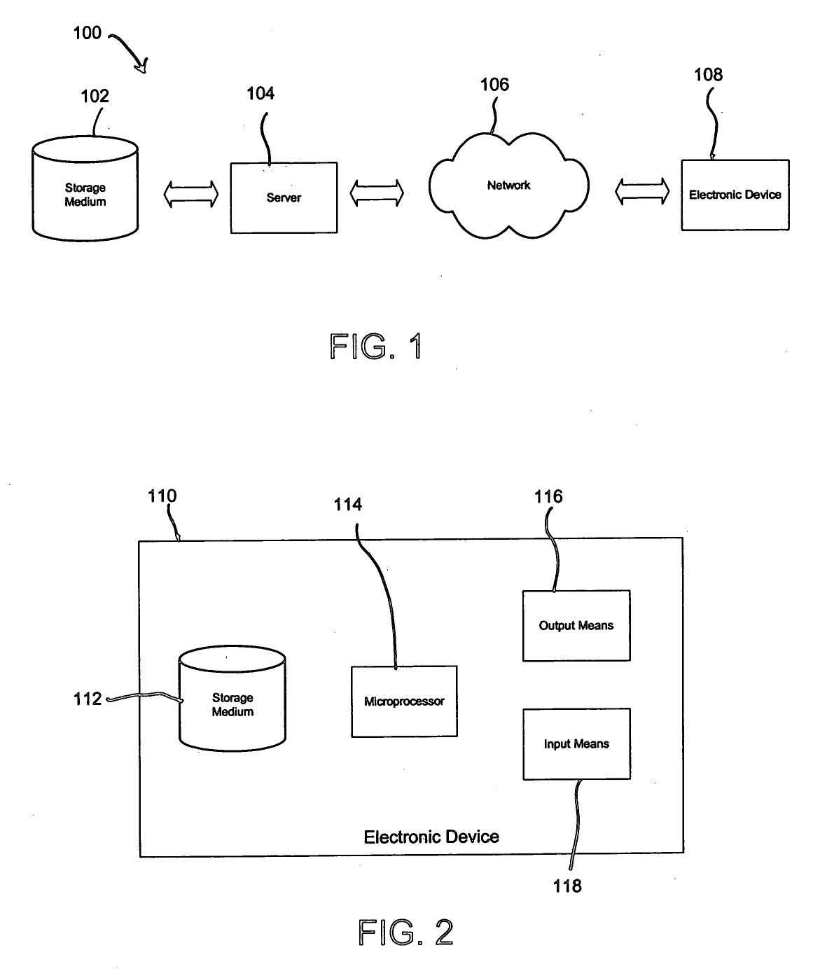

Referring now to FIG. 1, there is shown a system, generally indicated at 100, that may be utilized to play a game according to the principles of the present invention. System 100 comprises an electronic storage medium 102 for digital data such as a hard drive, a CD, a DVD, RAM, FLASH memory, a digital memory card, a game cartridge, a disc shaped object having data stored thereon that is read optically, a floppy disk or any other electronic storage medium that is now known or may be known in the future in the art. Artistic works are illustratively stored digitally on the storage medium 102 in a format compatible with their original medium and which facilitates implementation of the principles taught herein.

The artistic works may be digitally stored individually, i.e. each artistic work in its own file, or collectively in a single file in the electronic storage medium 102. The files may all have the same file format or different file format suited for the particular artistic work which it contains. Formats may include, without limitation, an audio file format, a video file format (including both audio and video information), a graphics or image file format or a text file format. Additional illustrative formats may include an animation and multimedia formats.

Illustrative formats which may be used in accordance with this detailed description may include music which is stored in an audio file format, a motion picture which is stored in a video format, a photograph which is stored in an image or graphics format, and a literary work which is stored in a text format. It will be appreciated that some artistic works may be capable of being saved in multiple formats.

Exemplary audio file formats include, without limitation: WAV (or WAVE), short for WAVEform audio format; MP3 (or, more precisely, MPEG-1/2 Audio Layer 3); WMA (Windows Media Audio) and MIDI (Musical Instrument Digital Interface).

Exemplary video file formats include, without limitation: REALMEDIA;™ QUICKTIME;™ and the multiple types of MPEG formats.

Exemplary image file formats include, without limitation: BMP or DIB (bitmapped graphics); GIF (Graphics Interchange Format); JPEG (Joint Photographic Experts Group); and TIFF (Tagged Image File Format).

It should be noted that the above listing of file formats is not comprehensive. Indeed, any type of file format now known or known in the future which is suitable for electronically storing an artistic work may be utilized with the present invention. Those skilled in the art will appreciate the various types of file formats, in addition to those listed above, that may be suitable for use with the present invention.

The storage medium 102 may also include an index, as will be discussed in more detail below, of some or all of the artistic works stored on the storage medium 102. The index may include the identifying indicia associated with each artistic work and a selection of game parameters. For example, the index may also include information about each artistic work such that the players may select only certain categories of artistic works in accordance with game parameters. It should be noted that each of the artistic works may have identifying indicia distinct from other artistic works. For example, a literary composition may have an identifying indica comprising the name of the author while a musical composition may have an identifying indicia comprising the name of a performer but not the composer. Thus, it will be observed that the artistic works may have different identifying indicia.

The storage medium 102 may also comprise web pages that may be served by the server 104 to an electronic device 108. The web pages may serve as an interface whereby the game may be played. The storage medium 102 may also comprise the program logic for the game as explained herein. It should be noted that storage medium 102 may be divided between several different storage mediums.

Server 104 retrieves and sends the files containing the artistic works over a network 106 to the electronic device 108 in response to commands by the players. The network 106 may be any network, including, without limitation, the Internet, WAN, LAN, telephone network, and cable network. Other types of networks now known or known in the future may be used as well. The connection between the network 106 and the electronic device 108 may be through an internet service provider (ISP) using various mediums including both wireless and wired networks. This may include access over, without limitation, a modem, cable modem, radio frequency device or T1 communication line. It will be appreciated that the mentioned network connections are exemplary and other means of establishing a communications link between the server 104 and the electronic device 108 may be utilized.

Server 104 may also serve as the game server, that is, server 104 may control game play. Server 104 may constitute multiple servers as is known in the art to both serve the web pages and control game play. Electronic device 108 may be a PC computer or workstation acting as a client. Typically running on a PC is an operating system as well as other applications as is well-known in the art. Electronic device 108 may also be a mobile telephone, a gaming system (for example, XBOX™, PLAYSTATION™, etc.), a hand held computer (for example, PALM™), or any other microprocessor based device that may be connected to and communicate data over a network.

The electronic device 108 should have a display and/or speakers (not specifically shown) on which artistic works may be rendered. Electronic device 108 should also have an input device (not specifically shown) for allowing a player to interface with the server 104 for controlling game, inputting game parameters and optionally inputting answers. The input device may include, without limitation, a keyboard, mouse, remote control, microphone, a controller, touch screen, and a keypad.

Applications running on the electronic device 108 should be able to render the files containing the artistic works such that they are perceivable by a person. These applications may include decoders of all types, including popular media players as are well known in the art. The applications may render streaming files or non-streaming files, as those skilled in the art will appreciate using the present disclosure.

Examples of applications that may be used to render the artistic files include, without limitation, a web browser, WINDOWS™ Media Player, REALONE™ Player, QUICKTIME™ Player, FLASH™ Player, as well as other players as are known to those skilled in the art and which become available in the future.

It will be appreciated that for purposes of illustration that only one electronic device 108 is illustrated in FIG. 1 but that multiple electronic devices 108 may be connected to server 104 to thereby allow multiplayer games where the players are located in distinct locations.

FIG. 2 shows a block diagram of an exemplary electronic device 110 which may be used to play the game in accordance with the principles of the present invention. In this embodiment, the game may be played without a network connection. The electronic device 110 comprises a storage medium 112 for storing the artistic work in digital file(s) in a similar fashion as described for storage medium 102 above. As described above, the storage medium 112 may comprise various types of storage mediums that will not be repeated here. The artistic works may be indexed such that they can be sorted during game play. Identifying indicia for each of the artistic works may also be stored in the storage medium 112.

The game logic may also be stored on the storage medium 112. A microprocessor 114 receives input from input means 118 to control game play and user commands. The input means may include, without limitation, a keyboard, mouse, remote control, microphone, touch screen, controller, and a keypad. The artistic works are rendered by microprocessor 114 on an output means 116. This may require the use of a software program which can be selected by those skilled in the art using the information set forth herein. The output means 116 may include, without limitation, a TV, computer monitor, LCD screen, and speakers. The electronic device 110 may be part of a system, such as a home entertainment system comprising a TV, a DVD player, a DVD, speakers and a remote.

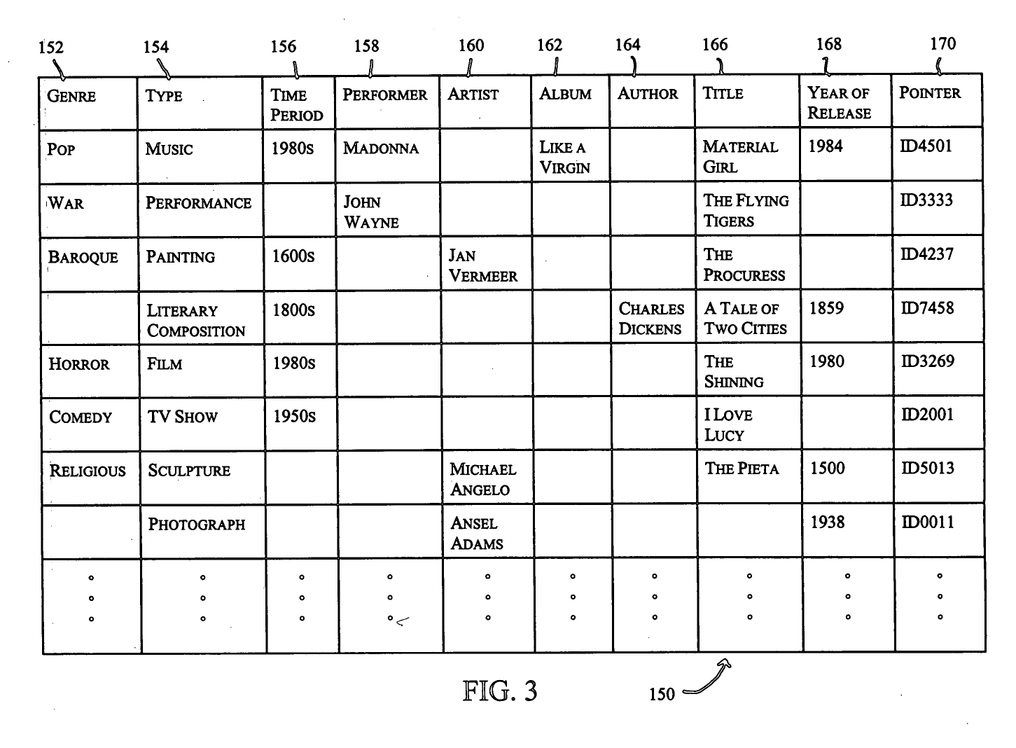

FIG. 3 illustrates a portion of an exemplary index, generally indicated at 150, comprising information regarding various artistic works. This exemplary index 150 illustrates only a small representation of artistic works that may be contained in the index in accordance with this disclosure. In addition, it should be understood that the information contained in the columns and rows is for illustrative purposed only, and that it is contemplated that the invention may have more or less information than shown in the exemplary index 150 represented in FIG. 3. Index 150 is shown as a table in which each row of the table, other than the top row, is associated with an artistic work. The top row comprises identifying indicia and selection parameters as well as one cell for pointer information, as will be explained below.

The first column 152 of the index 150 identifies a genre that may be associated with each artistic work. The listed exemplary genres in the first column are pop, war, baroque, horror, comedy, religious. It will be appreciated that this list is not comprehensive, but merely a sampling of the plurality of possible genres. Other genres, not specifically named herein, may be used as well. It will be noted that some artistic works may not have any genre associated with them. The genre information may be used as a selection parameter or an identifying indicia. For example, the players may select to limit the game to only pop music. Or the players could perceive the rendering of an artistic work and then attempt to identify the genre.

The second column 154 of the index 150 identifies a type of work that may be associated with each artistic work. The listed types in the this column 154 are music, performance, painting, literary composition, film, television production, television show, sculpture, photograph. It will be appreciated that this list is not comprehensive, but merely a sampling of the plurality of possible types of works. Other types, not specifically named herein, may be used as well. Generally, the players may use the type as a selection parameter. For example, the players may choose to limit the game to music or music and TV shows, or any other selection or combination.

The third column 156 of the index 150 identifies a time period that may be associated with each artistic work. Time periods may include decades, years, centuries and other divisions of time. It will be appreciated that this list is not comprehensive, but merely a sampling of the plurality of possible time periods. Other divisions of times, not specifically named herein, may be used as well. It will be noted that some artistic works may not have any time period associated with them. The time period information may be used as a selection parameter or an identifying indicia. For example, the players may select to limit the game to only artistic works from the 1800s. Or the players could perceive the rendering of an artistic work and then attempt to identify the appropriate time period.

The fourth column 158 of the index 150 identifies a performer that may be associated with each artistic work. It will be noted that some artistic works may not have any performer associated with them. The performer information may be used as a selection parameter or as an identifying indicia. For example, the players could limit the game to all artistic works by a particular performer. Or the players could perceive the rendering of an artistic work and then attempt to identify the appropriate performer.

The fifth column 160 of the index 150 identifies an artist, such as a painter or sculpture, that may be associated with each artistic work. It will be noted that some artistic works may not have any artist associated with them. The artist information may be used as a selection parameter or as an identifying indicia. For example, the players could limit the game to all artistic works by a particular artist. Or the players could perceive the rendering of an artistic work and then attempt to identify the appropriate artist.

The sixth column 162 of the index 150 identifies an album that may be associated with each artistic work. It will be noted that some artistic works may not have any album associated with them. The album information may be used as a selection parameter or as an identifying indicia. For example, the players could limit the game to all artistic works collected on a particular album. Or the players could perceive the rendering of an artistic work and then attempt to identify the appropriate album.

The seventh column 164 of the index 150 identifies an author that may be associated with each artistic work. It will be noted that some artistic works may not have any author associated with them. The author information may be used as a selection parameter or as an identifying indicia. For example, the players could limit the game to all artistic works by a particular author. Alternatively, the players could perceive the rendering of an artistic work and then attempt to identify the appropriate author.

The eighth column 166 of the index 150 identifies a title that may be associated with each artistic work. It will be noted that some artistic works may not have any title associated with them. The title information may be used as a selection parameter or as an identifying indicia. For example, the players could limit the game to all artistic works associated with a particular title. Or the players could perceive the rendering of an artistic work and then attempt to identify the appropriate title.

The ninth column 168 of the index 150 identifies a year of release that may be associated with each artistic work. It will be noted that some artistic works may not have any year of release associated with them. The year of release information may be used as a selection parameter or as an identifying indicia. For example, the players could limit the game to all artistic works associated with a particular year of release. Or the players could perceive the rendering of an artistic work and then attempt to identify the appropriate year of release. The tenth column 170 may identify a pointer to where the artistic work is stored such as in a database or the like.

It will be appreciated that index 150 may contain artistic works of only a single type. For example, the index may be all music or all literary works. Further, although FIG. 3 shows the index 150 in a tabular format, the index 150 may use any data storage technique and any type of data structure to store the artistic work information.

It should be noted that players do not provide answers to solely trivia questions. The present invention is unique because of the players must watch, observe, read and/or hear an artistic work being rendered and then try to provide the correct identifying indicia. At the beginning of a game, a player may choose game parameters that will limit the artistic works being rendered.

For example, additional game parameters may include, without limitation, the age of a person, the popularity of the artistic works, a genre, a time period, a name of a person, a style or a movement. Thus, a player may provide his or her age and the game may automatically, for example by way of an algorithm which can be arrived at using the information set forth herein, only provide artistic works that a person of that particular age would most likely be familiar with. Likewise, the players may choose only artistic works associated with a particular person. Or the players may choose a particular genre. More than one game parameter may be employed at one time to further limit the artistic works presented. It will be appreciated that the above-provided examples are illustrative only, and should not be construed as limiting on the scope of the present invention. But, it should be recognized that this feature allows the players to customize the game to the player's or players' preferences.

Also within the scope of this disclosure is that at the beginning of a game, the players may select an identifying indicia that will be identified with each type of artistic works. The players may select that more than one identifying indicia will be identified for some or all of the artistic works. For example, the players may select to attempt to identify solely a performer for each musical artistic work conveyed during the game. Or the players may choose to identify a performer and an album for each musical artistic work. Likewise, for each type of artistic works the players may have to select the appropriate identifying indicia to be surmised or guessed.

In one illustrative embodiment carried out in accordance with the present disclosure, a player may be designated as a game administrator whose role during game play is to select the artistic works. This is entertaining to the players and any observers because sometimes one player likes to try to nonplus or “stump” the other players with artistic works that he is familiar with but the others may not know.

Once the game parameters, if any, have been established, an artistic work is retrieved and rendered. Where there are multiple players, the players compete to be the first to ascertain the proper identifying indicia of the artistic work. The game may be played by having the players yell out the answer or the players may input their answers for electronic verification. The players then trigger the verification of the answer. The correct answer may be visually or audibly transmitted to the players for verification. If the player is correct, then the player may be awarded a score or a prize. In another illustrative embodiment of the present invention the player or players are provided with multiple choices from which to choose an answer. In one illustrative embodiment of the present invention, the players may utilize a game board with pieces. The pieces are advanced for correct answers. Various types of game boards may be used with the present invention as is known in the art and will not be recited in detail here.

The game can continue by rendering additional artistic works. The players may trigger the rendering of the next artistic work. Game play may stop when a winning score has been achieved or some other reason to terminate the game. It should be noted that this game may also be played with teams of players.

As mentioned above, another aspect of this disclosure is the placement of targeted advertisements during game play. The advertisements may be targeted to individual players or groups of players based upon the game parameters, also referred to herein as selection parameters, selected by the players and/or the players knowledge of the artistic works. These advertisements may be presented in a number of different ways, including pop-up advertisements, banner advertisements, audio advertisements, video advertisements (such as commercials presented on television broadcasts), e-mails, splash screens and links to web pages.

For example, if the answers of a player or a group of players during game play indicates a particular knowledge in a certain area, advertisements may be targeted to those players for products and/or services relating to the certain area. Thus, if the system determines from the game play that the players are knowledgeable with music in the country genre then targeted advertisements for country music albums and other related products may be delivered during game play.

In addition, the game parameters selected by a player may also indicate which targeted advertisements are likely to be successful. For example, if the players indicate that they want the artistic works limited to 19^{th} century literary works, advertisements for products relating to 19^{th} century literary works or related products could be presented during game play.

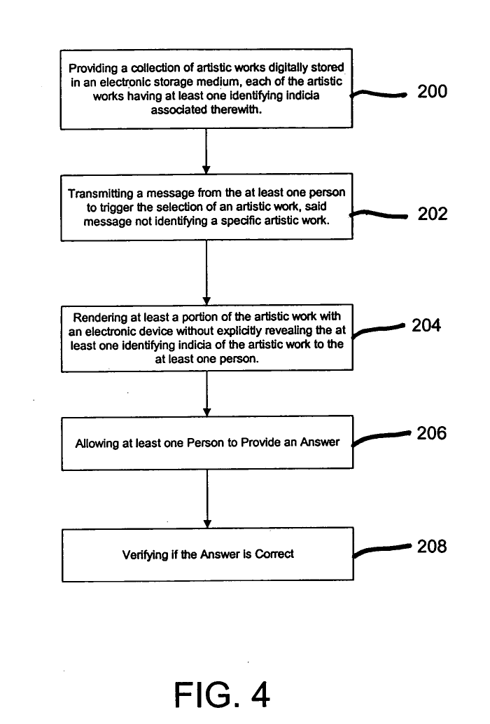

Reference will now be made to the exemplary flow charts of FIGS. 4-9 which are incorporated herein in their entireties. Several different illustrative embodiments of the present invention are represented in FIGS. 4-9 showing various steps that may be used for carrying out the present invention.

With reference to the flow diagram of FIG. 4, in one illustrative embodiment of the present invention, there is represented a method to play a game in accordance with the principles of the present invention. The first step is to provide a collection of artistic works digitally stored in an electronic storage medium (Step 200). Each of the artistic works should have at least one identifying indicia associated therewith. Next, a player transmits a message to trigger the selection of an artistic work but the message should not generally identify the specific artistic work (Step 202). The selected artistic work is then rendered such that the player or players may perceive the artistic work (Step 204). During the rendering, or shortly thereafter, one of the players may provide an answer in an attempt to guess the indicia (Step 206). The answer then may be verified to see of it is correct (Step 208).

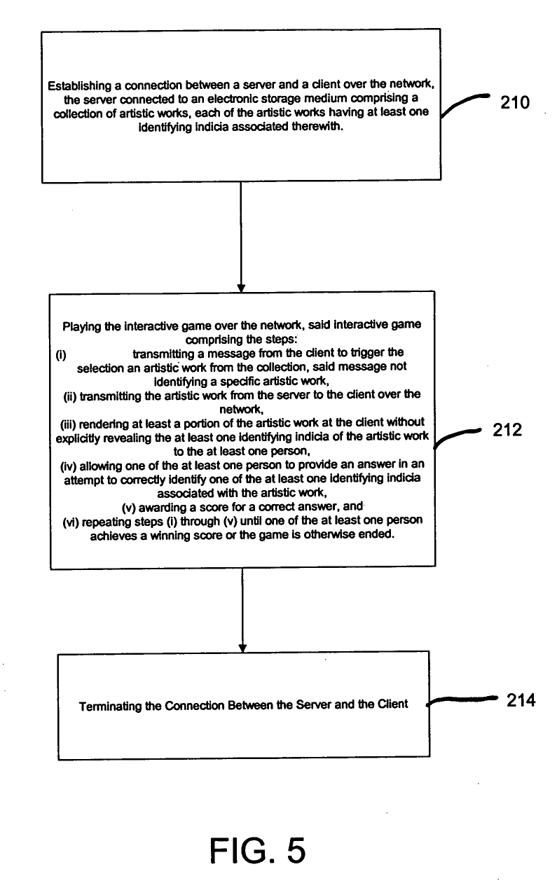

With reference to the flow diagram of FIG. 5, in one illustrative embodiment of the present invention, there is represented a method to play a game in accordance with the principles of the present invention. The first step is to establish a connection between a server and a client over a network (Step 201). The server should have access to an electronic storage medium comprising a collection of artistic works, each of the artistic works having at least one identifying indicia associated therewith. Next, the game is played over the network (Step 212). Playing the game comprises the steps of (i) transmitting a message from the client to trigger the selection an artistic work from the collection, said message not identifying a specific artistic work, (ii) transmitting the artistic work from the server to the client over the network, (iii) rendering at least a portion of the artistic work at the client without explicitly revealing the at least one identifying indicia of the artistic work to the at least one person, (iv) allowing one of the at least one person to provide an answer in an attempt to correctly identify one of the at least one identifying indicia associated with the artistic work, (v) awarding a score for a correct answer, and (vi) repeating steps (i) through (v) until one of the at least one person achieves a winning score or the game is otherwise ended. The connection between the client and server is terminated when the game is complete (Step 214).

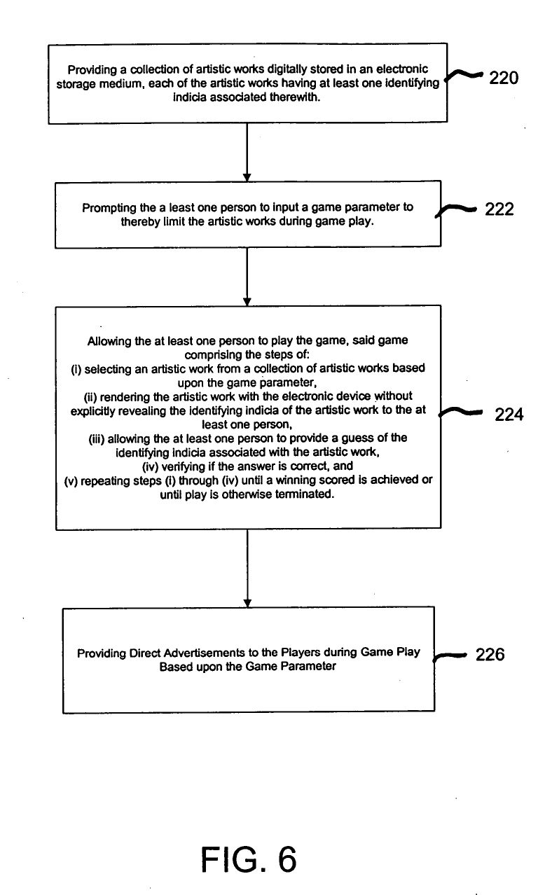

With reference to the flow diagram of FIG. 6, in another illustrative embodiment of the present invention, there is represented a method to play a game in accordance with the principles of the present invention. The first step is to provide a collection of artistic works stored in an electronic storage medium (Step 220). The player or players are then prompted to enter a game or selection parameter (Step 222). Next, the game is played (Step 224). The game play comprises the steps of (i) selecting an artistic work from a collection of artistic works based upon the game parameter, (ii) rendering the artistic work with the electronic device without explicitly revealing the identifying indicia, (iii) allowing the at least one person to provide a guess of the identifying indicia associated with the artistic work, (iv) verifying if the answer is correct, and (v) repeating the previous steps until a winning score is achieved or until play is otherwise terminated. During the game play, directed advertisements are provided to the players based upon the game or selection parameter (Step 226).

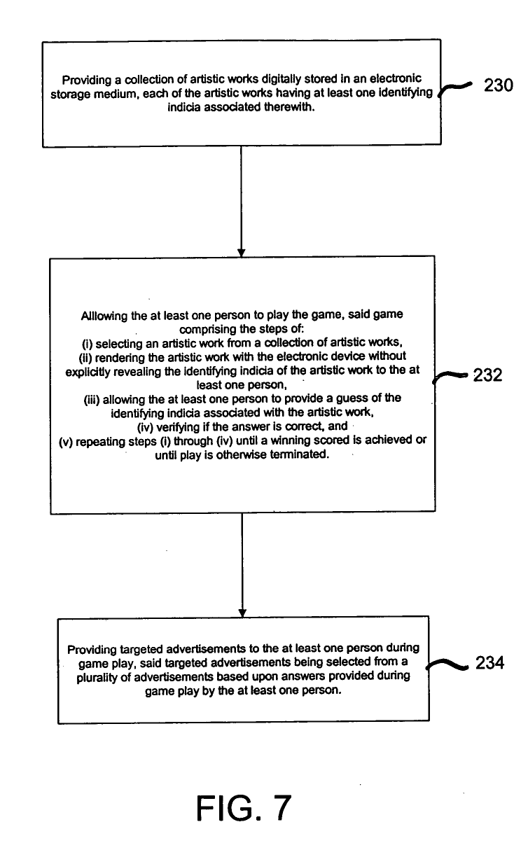

With reference to the flow diagram of FIG. 7, in yet another illustrative embodiment of the present invention, there is represented a method to play a game in accordance with the principles of the present invention. The first step is to provide a collection of artistic works stored in an electronic storage medium (Step 230). Next, the game is played (Step 232). The game play comprises the steps of (i) selecting an artistic work from a collection of artistic works based upon the game parameter, (ii) rendering the artistic work with the electronic device without explicitly revealing the identifying indicia, (iii) allowing the at least one person to provide a guess of the identifying indicia associated with the artistic work, (iv) verifying if the answer is correct, and (v) repeating the previous steps until a winning score is achieved or until play is otherwise terminated. During the game play, directed advertisements are provided to the players based upon the answers given during game play (Step 234).

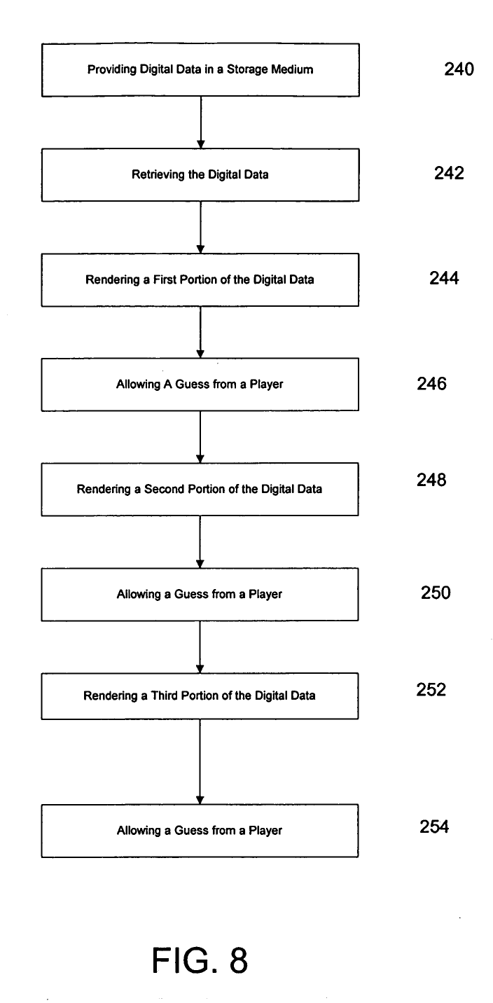

With reference to the flow diagram of FIG. 8, in still another illustrative embodiment of the present invention, there is represented a method to play a game in accordance with the principles of the present invention. The first step is to provide a collection of digital data in a storage medium (Step 240). The data is then retrieved (242). A first portion of the digital data is rendered (Step 244) to be perceived by a player and the player attempts to guess something about the data (Step 246). A second portion of the digital data is rendered (Step 248) and a player provides a guess about the data (Step 250). A third portion of the data is rendered (Step 252) and a player provides a guess about the data (Step 254).

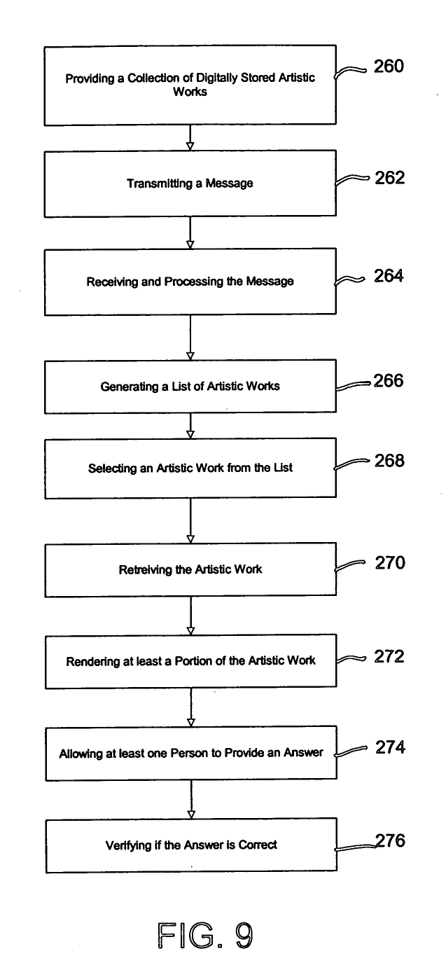

With reference to the flow diagram of FIG. 9, in a yet further illustrative embodiment of the present invention, there is represented a method to play a game in accordance with the principles of the present invention. The first step is to provide a collection of artistic works digitally stored in an electronic storage medium, each of the artistic works having at least one identifying indicia associated therewith (Step 260). The next step is to transmit a message from the at least one person (Step 262). The next step is to receive and process the message from the at least one person (Step 264) and to generate a list of artistic works (Step 266). An artistic work is automatically selected from the list of artistic works (Step 268). The artistic work is retrieved (Step 270) and rendered (Step 272). A player then may attempt to guess the identifying indicia associated with the work (Step 274) and the answer is verified to see if it is correct (Step 276).

Appendix A, incorporated herein by reference in its entirety, contains pseudo-code CLASS declarations for a generalized computer implementation of one illustrative embodiment of the present invention. The material of Appendix A is merely exemplary and not limiting of the scope of the present invention.

It will be appreciated that the particular structure and apparatus disclosed herein is merely exemplary of a means for providing an answer, and it should be appreciated that any structure, apparatus or system for providing an answer which performs functions the same as, or equivalent to, those disclosed herein are intended to fall within the scope of a means for providing an answer, including those structures, apparatus or systems for providing an answer which are presently known, or which may become available in the future. Any structure which functions the same as, or equivalently to, a means for providing an answer falls within the scope of this inventive element.

It will also be appreciated that the structure and apparatus disclosed herein is merely exemplary of a means for digitally storing a collection of artistic works, and it should be appreciated that any structure, apparatus or system for digitally storing a collection of artistic works which performs functions the same as, or equivalent to, those disclosed herein are intended to fall within the scope of a means for digitally storing a collection of artistic works, including those structures, apparatus or systems for digitally storing a collection of artistic works which are presently known, or which may become available in the future. Any structure which functions the same as, or equivalently to, a means for digitally storing a collection of artistic works falls within the scope of this inventive element.

It will further be appreciated that the structure and apparatus disclosed herein is merely exemplary of a means for rendering, and it should be appreciated that any structure, apparatus or system for rendering which performs functions the same as, or equivalent to, those disclosed herein are intended to fall within the scope of a means for rendering, including those structures, apparatus or systems for rendering which are presently known, or which may become available in the future. Any structure which functions the same as, or equivalently to, a means for rendering falls within the scope of this element.

It will also be appreciated that the structure and apparatus disclosed herein is merely exemplary of a means for selecting an artistic work from the collection of artistic works, and it should be appreciated that any structure, apparatus or system for selecting an artistic work from the collection of artistic works which performs functions the same as, or equivalent to, those disclosed herein are intended to fall within the scope of a means for selecting an artistic work from the collection of artistic works, including those structures, apparatus or systems for selecting an artistic work from the collection of artistic works which are presently known, or which may become available in the future. Any structure which functions the same as, or equivalently to, a means for selecting an artistic work from the collection of artistic works falls within the scope of this inventive element.

It will furthermore be appreciated that the structure and apparatus disclosed herein is merely exemplary of a means for receiving and processing a message, and it should be appreciated that any structure, apparatus or system for receiving and processing a message which performs functions the same as, or equivalent to, those disclosed herein are intended to fall within the scope of a means for receiving and processing a message, including those structures, apparatus or systems for receiving and processing a message which are presently known, or which may become available in the future. Any structure which functions the same as, or equivalently to, a means for receiving and processing a message falls within the scope of this inventive element.

It will also be appreciated that the structure and apparatus disclosed herein is merely exemplary of a means for transmitting a message, and it should be appreciated that any structure, apparatus or system for transmitting a message which performs functions the same as, or equivalent to, those disclosed herein are intended to fall within the scope of a means for transmitting a message, including those structures, apparatus or systems for transmitting a message which are presently known, or which may become available in the future. Any structure which functions the same as, or equivalently to, a means for transmitting a message falls within the scope of this inventive element.

Those having ordinary skill in the relevant art will appreciate the advantages provided by the features of the present disclosure. For example, it is a feature of the present disclosure to provide a method and apparatus for testing players' knowledge of artistic works. Another feature of the present disclosure is to provide targeted advertisements during game play.

In the foregoing Detailed Description, various features of the present disclosure are grouped together in a single embodiment or multiple embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description by this reference, with each claim standing on its own as a separate embodiment of the present disclosure.

It is to be understood that the above-described arrangements are only illustrative of the application of the principles of the present disclosure. Numerous modifications and alternative arrangements may be devised by those skilled in the art without departing from the spirit and scope of the present disclosure and the appended claims are intended to cover such modifications and arrangements. Thus, while the present disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

1. A method for providing entertainment to at least one person, said method comprising the steps of:
(A) providing a collection of artistic works digitally stored in an electronic storage medium, each of the artistic works having at least one identifying indicia associated therewith;
(B) transmitting a message from the at least one person to trigger the selection of an artistic work, said message not identifying a specific artistic work;
(C) rendering at least a portion of the artistic work with an electronic device without explicitly revealing the at least one identifying indicia of the artistic work to the at least one person;
(D) allowing one of the at least one person to provide an answer in an attempt to correctly identify one of the at least one identifying indicia associated with the artistic work; and
(E) verifying if the answer is correct.

2. The method of claim 1 further comprising the step of awarding a score for a correct answer.

3. The method of claim 1 further comprising the step of generating a list of artistic works, said list comprising artistic works stored in the collection of artistic works.

4. The method of claim 1 further comprising the step of digitally storing the artistic works in the electronic storage medium in an audio file format, a video file format, an image file format, or a text file format.

5. The method of claim 1 further comprising the step of digitally storing a first portion of the artistic works in a first file format and a second portion of the artistic works in a second file format, the first and second file formats being different from each other.

6. The method of claim 1 further comprising the step of digitally storing a first portion of the artistic works in a first file format, a second portion of the artistic works in a second file format, and a third portion of the artistic works in a third file format, the first, second and third file formats being different from each other.

7. The method of claim 1 wherein each of the artistic works is selected from the group consisting of musical performances, acting performances, paintings, and literary works.

8. The method of claim 1 wherein at least one of the artistic works is a musical performance and at least one of the artistic works is an acting performance.

9. The method of claim 1 wherein at least one of the artistic works is an excerpt from a book.

10. The method of claim 1 wherein at least one of the artistic works is a musical performance.

11. The method of claim 1 wherein at least one of the artistic works is an acting performance from a movie, play or TV show.

12. The method of claim 1 wherein at least one of the artistic works is poetry.

13. The method of claim 1 wherein at least one of the artistic works is a painting.

14. The method of claim 1 wherein each of the at least one identifying indicia for each of the artistic works is stored in a database.

15. The method of claim 1 wherein the at least one identifying indicia for at least one of the artistic works comprises the name of a person.

16. The method of claim 15 wherein the at least one identifying indicia for at least one of the artistic works comprises the name of a performer, an author, an actor and a painter.

17. The method of claim 1 wherein the at least one identifying indicia for at least one of the artistic works comprises a title of an album or a song.

18. The method of claim 1 wherein the at least one identifying indicia for at least one of the artistic works comprises a title of a movie.

19. The method of claim 1 wherein the at least one identifying indicia for at least one of the artistic works comprises the name of a band.

20. The method of claim 1 wherein the at least one identifying indicia for at least one of the artistic works comprises a year.

21. The method of claim 1 wherein the at least one identifying indicia for at least one of the artistic works comprises a name of a genre, movement or style.

22. The method of claim 1 further comprising the step of prompting the at least one person to choose a selection parameter, and wherein the step of selecting an artistic work comprises the step of selecting the artistic work from the collection based upon the selection parameter.

23. The method of claim 22 wherein the selection parameter is an age of a player.

24. The method of claim 22 wherein the selection parameter is a genre.

25. The method of claim 22 wherein the selection parameter is a time period.

26. The method of claim 22 wherein the selection parameter is a name of a person.

27. The method of claim 22 wherein the selection parameter is a name of a time period.

28. The method of claim 22 wherein the selection parameter is a name of a style or a movement.

29. The method of claim 1 wherein the electronic storage medium is selected from the group consisting of a hard drive, a CD, a DVD, RAM, FLASH memory, a digital memory card, a game cartridge, a disc shaped object having data stored thereon that is read optically, and a floppy disk.

30. The method of claim 1 wherein the step of allowing the at least one person to provide an answer comprises the step of selecting an answer from a list of answers displayed electronically, said list of answers comprising a correct answer and at least one incorrect answer.

31. The method of claim 1 wherein the step of allowing the at least one person to provide an answer comprises the step of providing the answer without looking at a list of answers.

32. The method of claim 1 wherein the step of allowing the at least one person to provide an answer comprises the step of supplying a hint, said hint being displayed electronically.

33. The method of claim 1 wherein the step of sending a request comprises the step of providing a graphical user interface to allow the at least one person to send the request electronically.

34. The method of claim 33 wherein the graphical user interface is displayed on a computer display, a television, a cell phone screen, or a hand held computer screen.

35. The method of claim 34 further comprising the step of inputting a number of players through the graphical user interface.

36. The method of claim 34 further comprising the step of inputting a name for each of the players.

37. The method of claim 1 further comprising the step of displaying the correct answer.

38. The method of claim 1 wherein the electrical device is selected from the group consisting of a computer system, a home entertainment system, a mobile telephone, a gaming system and a hand held computer system.

39. The method of claim 1 wherein the at least one person comprises a first person and a second person and wherein the step of allowing one of the at least one person to provide an answer comprises the step of allowing the first person and second to compete to provide an answer first.

40. The method of claim 1 further comprising the step of repeating steps (B) through (H) until one of the at least one players achieves a winning score.

41. A method for playing a game of recognition over a network by at least one person, said method comprising the steps of:
establishing a connection between a server and a client over the network, the server connected to an electronic storage medium comprising a collection of artistic works, each of the artistic works having at least one identifying indicia associated therewith;
playing the interactive game over the network, said interactive game comprising the steps:
(i) transmitting a message from the client to trigger the selection of an artistic work from the collection, said message not identifying a specific artistic work,
(ii) transmitting the artistic work from the server to the client over the network,
(iii) rendering at least a portion of the artistic work at the client without explicitly revealing the at least one identifying indicia of the artistic work to the at least one person,
(iv) allowing one of the at least one person to provide an answer in an attempt to correctly identify one of the at least one identifying indicia associated with the artistic work,
(v) awarding a score for a correct answer, and
(vi) repeating steps (i) through (v) until one of the at least one person achieves a winning score or the game is otherwise ended; and
terminating the connection between the server and the client.

42. The method of claim 41 further comprising the step of digitally storing the artistic works as media files in the electronic storage medium.

43. The method of claim 41 further comprising the step of digitally storing the artistic works in the electronic storage medium in an audio file format, a video file format, an image file format, or a text file format.

44. The method of claim 41 further comprising the step of digitally storing a first portion of the artistic works in a first file format and a second portion of the artistic works in a second file format, the first and second file formats being different from each other.

45. The method of claim 41 further comprising the step of digitally storing a first portion of the artistic works in a first file format and a second portion of the artistic works in a second file format and a third portion of the artistic works in a third file format, the first, second and third file formats being different from each other.

46. The method of claim 41 wherein each of the artistic works is selected from the group consisting of musical performances, acting performances, paintings, and literary works.

47. The method of claim 41 wherein at least one the artistic works is an excerpt from a book.

48. The method of claim 41 wherein at least one of the artistic works is a musical performance.

49. The method of claim 41 wherein at least one of the artistic works is an acting performance from a movie, play or TV show.

50. The method of claim 41 wherein at least one of the artistic works is selected from the group consisting of poetry and paintings.

51. The method of claim 41 wherein each of the at least one identifying indicia for each of the artistic works is stored in a database.

52. The method of claim 41 wherein each of the at least one identifying indicia for at least one of the artistic works is selected from the group consisting of the name of a person, a title of an album, a title of a song, a title of a movie, the name of a band, a year, a name of a genre, a name of a movement, and a name of a style.

53. The method of claim 41 further comprising the step of prompting the at least one person to choose a selection parameter, and wherein the step of selecting an artistic work comprises the step of selecting the artistic work from the collection based upon the selection parameter.

54. The method of claim 53 wherein the selection parameter is selected from the group consisting of an age of a person, a genre, a time period, a name of a person, a name of a time period, a name of a style, and a name of a movement.

55. The method of claim 41 wherein the network is the Internet.

56. A method of providing targeted advertisements during play of a game on an electronic device by at least one person, said method comprising the steps of:
providing a collection of artistic works digitally stored in an electronic storage medium, each of the artistic works having at least one identifying indicia associated therewith;
prompting the a least one person to input a game parameter to thereby limit the artistic works during game play;
allowing the at least one person to play the game, said game comprising the steps of:
(i) selecting an artistic work from a collection of artistic works based upon the game parameter,
(ii) rendering the artistic work with the electronic device without explicitly revealing the identifying indicia of the artistic work to the at least one person,
(iii) allowing the at least one person to provide a guess of the identifying indicia associated with the artistic work,
(iv) verifying if the answer is correct, and
(v) repeating steps (i) through (iv) until a winning score is achieved or until play is otherwise terminated; and
providing a targeted advertisement to the at least one person during game play, said targeted advertisement being selected from a plurality of advertisements based upon the game parameter.

57. The method of claim 56 wherein the game parameter is selected from the group consisting of an age of a person, a genre, a time period, a name of a person, a name of a time period, a name of a band, a name of a style, and a name of a movement.

58. The method of claim 56 wherein the targeted advertisement comprises a pop-up advertisement on a web browser.

59. The method of claim 56 wherein the targeted advertisement comprises a banner advertisement on a web page.

60. The method of claim 56 wherein the targeted advertisement comprises an audio advertisement.

61. The method of claim 56 wherein the targeted advertisement comprises a video advertisement.

62. The method of claim 56 wherein the targeted advertisement comprises a web page.

63. A method of providing targeted advertisements during play of a game on an electronic device by at least one person, said method comprising the steps of:
providing a collection of artistic works digitally stored in an electronic storage medium, each of the artistic works having at least one identifying indicia associated therewith;
allowing the at least one person to play the game, said game comprising the steps of:
(i) selecting an artistic work from a collection of artistic works,
(ii) rendering the artistic work with the electronic device without explicitly revealing the identifying indicia of the artistic work to the at least one person,
(iii) allowing the at least one person to provide a guess of the identifying indicia associated with the artistic work,
(iv) verifying if the answer is correct, and
(v) repeating steps (i) through (iv) until a winning score is achieved or until play is otherwise terminated; and
providing targeted advertisements to the at least one person during game play, said targeted advertisements being selected from a plurality of advertisements based upon answers provided during game play by the at least one person.

64. The method of claim 63 wherein the targeted advertisement comprises a pop-up advertisement on a web browser.

65. The method of claim 63 wherein the targeted advertisement comprises a banner advertisement on a web page.

66. The method of claim 63 wherein the targeted advertisement comprises an audio advertisement.

67. The method of claim 63 wherein the targeted advertisement comprises a video advertisement.

68. The method of claim 63 wherein the targeted advertisement comprises a web page.

69. A method for playing an interactive game by at least one person, said method comprising the steps of:
providing digital data in an electronic storage medium;
retrieving the digital data from the electronic storage medium;
rendering a first portion of the digital data;
allowing the at least one person to provide a first guess of an identifying indicia associated with the first portion of the digital data;
rendering a second portion of the digital data;
allowing a player to provide a second guess of an identifying indicia associated with the second portion of the digital data;
rendering a third portion of the digital data; and
allowing a player to provide a third guess of an identifying indicia associated with the third portion of the digital data.

70. The method of claim 69 further comprising the step of re-rendering a first portion of the digital data to allow the at least one person to provide a second guess of an identifying indicia associated with the first portion of the digital data.

71. A method for providing entertainment to at least one person, said method comprising the steps of:
(A) providing a collection of artistic works digitally stored in an electronic storage medium, each of the artistic works having at least one identifying indicia associated therewith;
(B) transmitting a message from the at least one person;
(C) receiving and processing the message from the at least one person;
(D) generating a list of artistic works;
(E) automatically selecting an artistic work from the list of artistic works in the electronic storage medium;
(F) retrieving the artistic work from the electronic storage medium;
(G) rendering at least a portion of the artistic work with an electronic device without explicitly revealing the at least one identifying indicia of the artistic work to the at least one person;
(H) allowing one of the at least one person to provide an answer in an attempt to correctly identify one of the at least one identifying indicia associated with the artistic work;
(I) verifying if the answer is correct; and (J) repeating steps (E) through (I) until a winning score is achieved.

72. A system for providing entertainment to at least one person, said system comprising:
means for digitally storing a collection of artistic works, each of the artistic works having at least one identifying indicia associated therewith;
means for transmitting a message from the at least one person to trigger the selection an artistic work from the collection, said message not identifying a specific artistic work;
means for receiving and processing the message from the at least one person;
means for selecting an artistic work from the collection of artistic works in the electronic storage medium;
means for retrieving the artistic work from the electronic storage medium;
means for rendering at least a portion of the artistic work without explicitly revealing the at least one identifying indicia of the artistic work to the at least one person; and
means for allowing one of the at least one person to provide an answer in an attempt to correctly identify one of the at least one identifying indicia associated with the artistic work.

73. The system of claim 72 further comprising a means for generating a list of artistic works.

74. The system of claim 72 wherein the artistic works are stored in an audio file format, a video file format, an image file format, or a text file format.

75. The system of claim 72 wherein a first portion of the artistic works are stored in a first file format and a second portion of the artistic works a stored in a second file format.

76. The system of claim 72 wherein a first portion of the artistic works are stored in a first file format and a second portion of the artistic works a stored in a second file format and a third portion of the artistic works are stored in a third file format.

77. The system of claim 72 wherein each of the artistic works is selected from the group consisting of musical performances, acting performances, paintings and literary works.

78. A system for providing entertainment to at least one person, said system comprising:
means for providing a collection of artistic works digitally stored in an electronic storage medium, each of the artistic works having at least one identifying indicia associated therewith;
means for transmitting a message from the at least one person to trigger the selection of an artistic work, said message not identifying a specific artistic work;
means for rendering at least a portion of the artistic work with an electronic device without explicitly revealing the at least one identifying indicia of the artistic work to the at least one person;
means for allowing one of the at least one person to provide an answer in an attempt to correctly identify one of the at least one identifying indicia associated with the artistic work; and
means for verifying if the answer is correct.

79. A system for playing an interactive game of recognition over a network by at least one person, the system comprising:
means for providing a collection of artistic works digitally stored in an electronic storage medium, each of the artistic works having at least one identifying indicia associated therewith;
means for accessing the artistic works over the network;
means for playing the interactive game over the network comprising:
(i) means for transmitting a message to trigger the selection of an artistic work;
(ii) means for downloading at least a portion of the artistic work;
(iii) means for rendering a portion of the artistic work;
(iv) means for allowing the at least one person to provide an answer;
(v) means for awarding a score for a correct answer; and
(vi) means for repeating steps (i) through (v) until one of the at least one person achieves a winning score.

80. The system of claim 79 wherein a first portion of the artistic works are stored in a first file format and a second portion of the artistic works a stored in a second file format.

81. The system of claim 79 wherein a first portion of the artistic works are stored in a first file format and a second portion of the artistic works a stored in a second file format and a third portion of the artistic works are stored in a third file format.

82. The system of claim 79 wherein each of the artistic works is selected from the group consisting of musical performances, acting performances, paintings and literary works.

83. The system of claim 79 wherein the artistic works are stored in an audio file format, a video file format, an image file format, or a text file format.
